(19) United States
(12) Patent Application Publication
(10) Pub. No.: US 2003/0088666 A1
(43) Pub. Date: May 8, 2003

(54) Data collection node that utilizes HTTP transfer protocols for autonomous data transfers

(76) Inventor: Glenn R. Engel, Snohomish, WA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/005,580

(22) Filed: Nov. 7, 2001

(51) Int. Cl. G06F 15/16

(52) U.S. Cl. 709/224; 714/37

(57) ABSTRACT

A data collection node and method for using the same to autonomously collect data. The node has interfaces for receiving signals from a sensor, and for connecting the data collection node to a computer network. A controller in the node causes the node to be registered with a server connected to the computer network when the data collection node is first activated on the computer network. As part of the registration process, the server provides a Web page that provides access to data communicated by the controller. The controller generates data based on sensor measurements and communicates that data to the server via the computer network, preferably via HTTP. Users having access to the Web page can then access the data collected by the node. If a firewall is present between the server and the node, the controller preferably communicates with a proxy server.

### FIELD OF THE INVENTION

The present invention relates to data logging devices, and more particularly to data collection nodes on networks and the methods of using the same to collect data from sensors.

### BACKGROUND OF THE INVENTION

The computerization of data collection offers many advantages when data must be collected from a device over an extended period of time, and hence, measurement nodes for coupling measurement devices to computers are well known to the computer arts. Such nodes collect data from physical sensors such as temperature sensors or pressure transducers. The simplest form of node is connected to a personal computer that is near the node and directs the node's data collection. To provide the collected data to others, the personal computer that is connected to the node is typically connected to a local area network. If the local area network is remote from the sites at which the data is used, the Internet can be utilized to provide access to the node via the local computer.

This arrangement has two main disadvantages. First, a local computer or workstation must be provided and must be programmed to collect data from the node and store the collected data. In essence, each node requires a custom data collection program. This increases the cost of the data collection nodes. In addition, the time needed to implement a data collection scheme is significantly increased by the need to program the local computer.

Second, providing copies of the data to remote locations requires additional programming and customization if the remote network is outside the local area network and the local area network is protected by a firewall. An outside user wishing to access the data must do so by penetrating the firewall. This usually requires special network routing or custom firewall alterations. Once again, these features increase the cost of the data collection scheme and the time needed to put a data collection system in place.

In principle, a generalized data collection program can be provided for the computer that operates the node. However, such a program would need to be over inclusive, since “one size would need to fit all users”. As a result, the size of the computer would need to be larger than the minimum computer size needed to run the node.

Broadly, it is the object of the present invention to provide an improved data collection node and method of using the same.

These and other objects of the present invention will become apparent to those skilled in the art from the following detailed description of the invention and the accompanying drawings.

### SUMMARY OF THE INVENTION

The present invention is a data collection node and method for using the same to autonomously collect data. The data collection node includes an interface for receiving signals from a sensor, an interface for connecting the data collection node to a computer network, and a controller. The controller causes the data collection node to be registered with a server connected to the computer network when the data collection node is first activated on the computer network. As part of the registration process, the server provides a Web page that provides access to data communicated by the controller. The controller also generates data based on measurements of the received signals from the sensor and communicates that data to the server via the computer network, preferably via HTTP. Users having access to the Web page can then access the data collected by the data collection node. The controller can also receive data that determines the measurement protocol from the server. If a firewall is present between the server and the data collection node, the controller preferably communicates with a proxy server so that the firewall does not need to be altered to allow messages to reach the server.

### BRIEF DESCRIPTION OF THE DRAWINGS

FIG. 1 illustrates an exemplary data collection and analysis system that utilizes the present invention.

### DETAILED DESCRIPTION OF THE INVENTION

The present invention is based on a data collection node that connects to a local area network and posts its data to a node server using conventional hypertext transfer protocols. The server may be located at a site that is remote from the local area network. In this case, the data collection node penetrates any firewalls while posting its data as described below. The node server collects the data and stores it in a form that can be accessed by data users via a web page on the server.

It should be noted that a large number of data collection nodes may share the same node server. Hence, the cost of the server is spread over a large number of data collection nodes. The server provides the data collection node user with a large capacity data storage facility and computational power for dealing with the data. Hence, the data collection nodes do not need to include hardware and software for dealing with these aspects of the data collection problem. This server may be dedicated to serving data collection nodes and the users thereof, or the server may also provide other services that are unrelated to the data collection, storage, and analysis functions. Accordingly, a server having a large computational power and storage capacity can be utilized without substantially increasing the cost of the nodes.

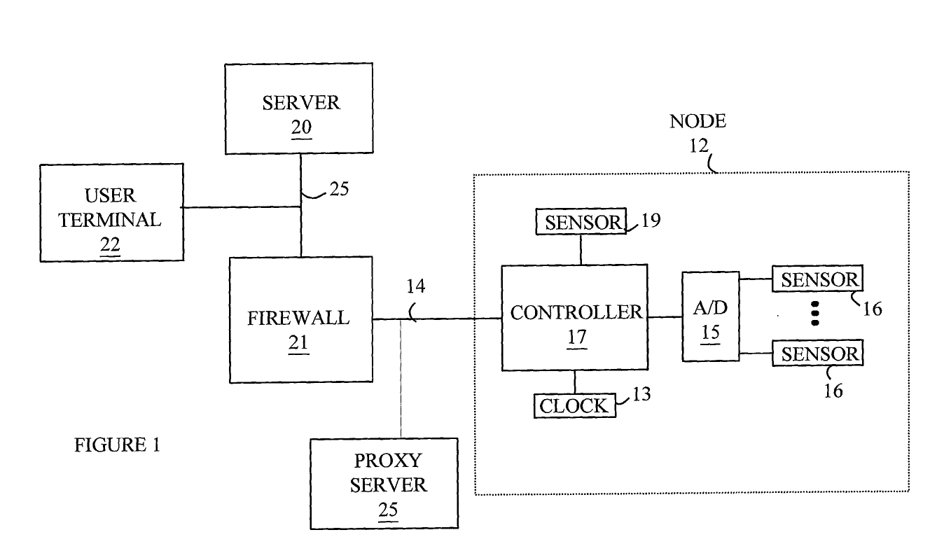

The manner in which a data collection node operates according to the present invention can be more easily understood with reference to the exemplary data collection and analysis system shown in FIG. 1. When data collection node 12 is first connected to network 14, data collection node 12 registers with server 20 by sending a message over network 14. The registration message preferably describes the data collection node and its capabilities. This includes information such as the node's serial number, manufacturer, and model number as well as information specifying the types of data that can be obtained from the node including the accuracy of the measurements, the maximum sample rate, the units in which the measurements are made, etc. In the preferred embodiment of the present invention, sufficient information about the node is transferred to the server to allow the server to do subsequent configuration and data collection in a generic manner but yet allow the user to see the data with appropriate units and annotation. Upon receiving the registration message from data collection node 12, server 20 takes the steps needed for establishing a data storage area for the node data on server 20. These steps depend on the particular application being implemented with the data collection node. The registration data is initially stored in a database that allows a user to subsequently access the web page and configure custom measurement settings such as sample rate or channel selection. The data collected from a device can be viewed as a web page for each device or it can be aggregated with other devices to show a composite view at a physical site or location. Access to the web page may require additional customer activation if a third party maintains the web page.

Node 12 then switches to a data collection mode. For the purposes of this discussion, it will be assumed that data collection node 12 includes an A/D converter 15 connected to one or more sensors 16 that provide analog data that is to be read and uploaded to server 20. Data collection node 12 also includes a clock 13 and a controller 17. Controller 17 is initially programmed with a default program that supervises the registration process discussed above. Additional programming information that specifies when measurements are to be made is also stored in controller 17. In the preferred embodiment of the present invention, this information can be updated by uploading the control data to server 20, which then sends the updated information back to data collection node 12.

In the simplest data measurement protocol, controller 17 uses A/D 15 to read the output of sensors 16 at predetermined times as determined by clock 13. For example, controller 17 could read the sensors once every minute. However, more complex data logging protocols can be utilized. For example, controller 17 could monitor one or more sensors and trigger a data logging event based on the input from these sensors. The triggering sensors may be one or more of the sensors connected to A/D converter 15 or an entirely separate group of sensors such as the sensor shown at 19. The logged data would then be uploaded to server 20 along with the time at which the measurements were made. In addition to the raw data, the data collection node can generate synthetic data such as a moving average or other values derived from one or more measurements.

In the preferred embodiment of the present invention, the server returns a message that contains the time on the server's clock when responding to a message from the data collection node. The time information can be used by the data collection node to set its clock. In addition, the data collection node may include a GPS receiver that generates an independent clock signal. Hence, the node clock will be correct even if the data collection node loses power for some period of time. This feature of the present invention is particularly useful in environments in which the data collection node is at a remote site that lacks personnel having the training or the time to reset the data collection node in the event of a power failure.

The data collection node may be connected to the server through the Internet 25 or other insecure communication link. In this case, a firewall 21 may be utilized to protect the local area network 14 from unauthorized access via the network segment 15. In this case, a data collection node according to the present invention preferably includes the necessary software to post data through the firewall without making any changes to the firewall. In the simplest version of this embodiment of the present invention, a proxy server 25 is utilized to post the data. The data is posted in a manner analogous to that used when data in a form is sent from a web browser on the network to a server that is on the other side of a firewall. To take advantage of this feature of the Internet, the data collection node needs to know the IP address and port number of the proxy server. The node then sends its data to the proxy server at the IP address using the port. It should also be noted that a reply message from the server will also pass through the firewall, and hence, information can be downloaded to the data collection node provided the data collection node initiates the exchange.

This embodiment of the present invention requires the node to initiate the communication with the server. If the node is periodically sending data back to the server, this is not a problem, since any data to be downloaded from the server to the data collection node can be sent as a return message. If the server needs to send information back to the data collection node during a time period at which the data collection node is not already initiating a transfer, the server can send the data collection node an e-mail directing it to send a message back to the server. The server can also use other techniques such as sending-a wireless page to request that the node communicate with it. In addition, the server can contact another computer on a local network that includes the node and request that computer to send a message to the node.

It should be noted that server 20 may belong to the same entity that owns the data collection nodes or server 20 may be provided by an independent entity. For example, server 20 can be provided by the same entity that sells the data collection nodes. The data collection node supplier can provide a standard secure Web page for each user. The data collected from the data collection nodes that is stored on the server is accessed through this Web page. Similarly, data that is to be communicated to the controllers in the data collection nodes can be uploaded to the server, which communicates the data to the data collection nodes. Hence, the user need only be familiar with a standard personal computer and the Web page in question.

This further simplifies the problem of setting up a data collection system in that the entity setting up the system does not have to setup server 20 as well. Server 20 can provide data storage and data analysis routings as well as the interface for connecting the user to the system. Hence, the user need only place the data collection nodes at the desired locations and log onto the internet to view, analyze, and download the collected data using a standard browser.

Various modifications to the present invention will become apparent to those skilled in the art from the foregoing description and accompanying drawings. Accordingly, the present invention is to be limited solely by the scope of the following claims.

What is claimed is:

1. A data collection node comprising:
an interface for receiving signals from a sensor;
an interface for connecting said data collection node to a computer network; and
a controller for generating data based on measurements of said received signals and communicating that data to a server via said computer network.

2. The data collection node of claim 1 wherein said controller causes said data collection node to be registered with said server connected to said computer network when said data collection node is first activated on said computer network.

3. The data collection node of claim 1 wherein said controller communicates said data via HTTP.

4. The data collection node of claim 1 wherein said controller receives data from said server that determines a measurement to be made by said controller.

5. The data collection node of claim 1 wherein said controller communicates with said server via a proxy server on said computer network.

6. The data collection node of claim 1 further comprising a clock for generating time readings that are included with data that is communicated to said server.

7. The data collection node of claim 6 wherein said clock is set via a message received from said server.

8. A method for operating a computer network to collect data, said method comprising the steps of:
providing a data collection node connected to said network, said data collection node comprising:
an interface for receiving signals from a sensor; and
a controller for generating data based on measurements of said received signals and communicating that data to a server via said computer network;
causing said server to provide a web page for accessing data generated by said controller in response to receiving said registration message; and
causing said controller to send a message to said server containing data generated by said controller after said controller sends said registration message.

9. The method of claim 8 further comprising the step of causing said controller to send a registration message to said server prior to communicating said data to said server.

10. The method of claim 8 wherein said controller communicates said message containing said data via HTTP.

11. The method of claim 8 wherein said controller receives data from said server that determines a measurement made by said controller.

12. The method of claim 8 wherein said controller communicates with said server via a proxy server on said computer network.

13. The method of claim 8 wherein said data collection node further comprises a clock for generating time readings that are included with data that is communicated to said server.

14. The method of claim 13 further comprising the step of resetting said clock to a time determined by a message received from said server.

15. The method of claim 8 further comprising the step of providing access to said Web page via the Internet.
